(19) United States
(12) Patent Application Publication
(10) Pub. No.: US 2010/0073967 A1
(43) Pub. Date: Mar. 25, 2010

(54) SWITCHING CONTROL CIRCUIT AND SWITCHING POWER SUPPLY

(76) Inventors: Naohisa TATSUKAWA, Osaka (JP); Satoru Takahashi, Shiga (JP); Yoshiaki Hachiya, Shiga (JP)

Correspondence Address: MCDERMOTT WILL & EMERY LLP, 600 13TH STREET, NW, WASHINGTON, DC, 20005-3096, US

(21) Appl. No.: 12/485,441

(22) Filed: Jun. 16, 2009

(30) Foreign Application Priority Data
Sep. 24, 2008 (JP) 2008-244797

(51) Int. Cl. H02M 3/335

(52) U.S. Cl. 363/21.18

(57) ABSTRACT

A switching element controls supply of a primary current to a transformer. A basic signal generator circuit generates a PWM basic signal regardless of a control condition of the switching element. A timer circuit measures an elapsed, predetermined longer time than one cycle of the PWM basic signal since a start of ON control of the switching element. A control circuit ON controls the switching element when receiving the PWM basic signal, and OFF controls the switching element when receiving either one of a first OFF signal based on output feedback of a switching power supply and a second OFF signal based on completion of time measuring by the timer circuit.

### CROSS-REFERENCE TO RELATED APPLICATION

This application claims priority under 35 U.S.C. §119(a) on Japanese Patent Application No. 2008-244797 filed on Sep. 24, 2008, the entire contents of which are hereby incorporated by reference.

### BACKGROUND OF THE INVENTION

The present disclosure relates to a PWM (pulse width modulation) switching power supply, and more particularly relates to a switching control circuit of the PWM switching power supply.

Switching power supplies have been widely used for power converters, such as AC-DC converters, DC-DC converters and the like, for converting input power into direct current power. In general, a switching power supply performs PWM control of a switching element to repeat a supply of a primary current to a transformer and a halt of the supply, thereby converting input power to desired direct current power.

As described above, in a switching power supply, a switching element repeats switching ON/OFF without interruption. Thus, an output voltage of the switching power supply is not immediately increased when an input voltage is low at a time of start-up or the like, and is reduced when an output load is increased. Therefore, it is desired that, when an input voltage is low, the switching element is continuously ON controlled so that a power supply capacity is improved. However, when the switching element is being ON controlled for a long time, a current continuously flows through the switching element for a long time and a breakdown of the element might be caused. To cope with this, a maximum ON time of the switching element is prolonged, in order to improve the power supply capacity when the input voltage is low while protecting the switching element (see, for example, Patent Document 1).

Also, since a switching frequency of the switching element is relatively high, the switching power supply radiates switching noise. Since the switching noise causes malfunction of peripheral electronic devices, it is desired to suppress the switching noise as much as possible. To solve this EMI (electromagnetic interference) problem, peaks of the switching noise are suppressed by causing a PWM basic frequency to fluctuate to spread the spectrum of the switching noise (see, for example, Patent Document 2).
Patent Document 1: Japanese Published Application No. 2007-20395
Patent Document 2: U.S. Pat. No. 6,249,876 specification

### SUMMARY OF THE INVENTION

In FIG. 5, FIG. 6, the paragraphs [0037] through [0049] of Patent Document 1, it is descried that the frequency of an oscillator is variable with respect to a first power supply input voltage condition. Therefore, in the switching power supply disclosed in Patent Document 1, measures for switching noise suppression over a frequency band might have to be taken. However, such measures for switching noise suppression cause increase in cost of the switching power supply. Specifically, the switching frequency of the switching power supply disclosed in Patent Document 1 is a variable switching frequency based on a pulse width modulation scheme. Therefore, a noise filter configured to include more components, compared to a pulse width modulation scheme of a fixed frequency, in consideration of frequency band might have to be provided at an input/output line of the switching power supply.

In view of the above-described problem, an example switching control circuit may improve a power supply capacity when an input voltage is low while restricting a switching frequency of a switching power supply to a narrow band.

The detailed description describes a switching control circuit for performing PWM control of a switching element which controls supply of a primary current to a transformer in a switching power supply for converting input power to direct current power, the switching control circuit including: a basic signal generator circuit for generating a PWM basic signal regardless of a control state of the switching element; a timer circuit for measuring an elapsed, predetermined longer time than one cycle of the PWM basic signal since a start of ON control of the switching element; and a control circuit for ON controlling the switching element when receiving the PWM basic signal, and OFF controlling the switching element when receiving either one of a first OFF signal based on output feedback of the switching power supply and a second OFF signal based on completion of time measuring by the timer circuit. Also, the detailed description describes a switching power supply for converting input power to direct current power, the switching power supply including: a transformer; a switching element, connected to a primary winding of the transformer, for controlling supply of a primary current to the transformer; a rectifier element, connected to a secondary winding of the transformer, for rectifying a secondary current of the transformer; a smoothing element for smoothing a current rectified by the rectifier element to generate a direct current voltage; a basic signal generator circuit for generating a PWM basic signal regardless of a control state of the switching element; a timer circuit for measuring an elapsed, predetermined longer time than one cycle of the PWM basic signal since a start of ON control of the switching element; and a control circuit for ON controlling the switching element when receiving the PWM basic signal, and OFF controlling the switching element when receiving either one of a first OFF signal based on output feedback of the switching power supply and a second OFF signal based on completion of time measuring by the timer circuit.

With the above-described configuration, a power supply capacity when an input voltage is low can be improved by continuously ON controlling the switching element for a longer time period than one cycle of the PWM basic signal. Furthermore, the basic signal generator circuit generates the PWM basic signal regardless of a control state of the switching element, so that a switching frequency of the switching element is a positive integer multiple of one cycle of the PWM basic signal. Accordingly, peaks of switching noise can be restricted to a PWM basic frequency and harmonic components thereof. Therefore, switching noise suppression can be achieved in a simple manner.

The switching control circuit preferably includes a mask circuit for masking, when receiving the first OFF signal, the PWM basic signal to be input to the control circuit for a certain period. Thus, a time period in which the switching element is non-conductive can be ensured, so that a current flowing through the switching element can be completely blocked.

Specifically, the timer circuit includes: a constant current source; a capacitor having one end grounded; a first switch, connected between an output end of the constant current source and the other end of the capacitor, for switching between a conductive state and a non-conductive state so that the first switch is in the conductive state while the switching element is ON controlled, and is in the non-conductive state while the switching element is OFF controlled; a second switch, connected in parallel to the capacitor, for switching between a conductive state and a non-conductive state so that the second switch is in the non-conductive state while the switching element is ON controlled, and is in the conductive state while the switching element is OFF controlled; and a comparator for comparing a charge voltage of the capacitor to a reference voltage. Alternatively, the timer circuit includes: a clock signal generator circuit for generating a clock signal having a higher frequency than that of the PWM basic signal; and a clock counter for counting edges of the clock signal for a predetermined number of times since a start of ON control of the switching element.

The basic signal generator circuit preferably causes a frequency of the PWM basic signal to fluctuate according to a fluctuating signal input to the basic signal generator circuit. Thus, since the PWM basic frequency continuously varies according to the fluctuating signal, a spectrum of switching noise is spread and peaks of switching noise are suppressed.

Specifically, the switching control circuit includes: a triangular wave generator circuit for generating a triangular wave signal; and a fluctuation generator circuit for generating the fluctuating signal, based on the triangular wave signal. Alternatively, the switching control circuit includes: a counter for performing a count operation; and a fluctuation generator circuit, including a plurality of constant current sources, for changing a number of parallel connections among the plurality of constant current sources according to an output value of the counter and outputting, as the fluctuating signal, a sum current flowing therethrough.

Moreover, specifically, the switching control circuit includes: an amplifier circuit for amplifying any one of an input ripple and an output ripple of the switching power supply, and an output ripple of an auxiliary winding of the transformer; and a fluctuation generator circuit for generating the fluctuating signal, based on an output of the amplifier circuit. Alternatively, the switching control circuit includes: a feedback circuit for receiving either one of a detection of an output of the switching power supply and a detection of an output of an auxiliary winding of the transformer to generate a feedback signal based on which the first OFF signal is generated; and a fluctuation generator circuit for generating the fluctuating signal, based on either one of an output ripple of the switching power supply and an output ripple of the auxiliary winding which are amplified by the feedback circuit. As another option, the switching control circuit includes: a feedback circuit for receiving a detection of an input of the switching power supply and a detection of an output of the switching power supply (or a detection of an output of an auxiliary winding of the transformer) to generate a feedback signal based on which the first OFF signal is generated; and a fluctuation generator circuit for generating the fluctuating signal, based on an input ripple and an output ripple of the switching power supply (or an output ripple of the auxiliary winding of the transformer) which are synthesized and amplified by the feedback circuit.

### BRIEF DESCRIPTION OF THE DRAWINGS

FIG. 1 is a block diagram of a switching power supply according to a first embodiment.

FIG. 2 is a diagram illustrating an example configuration of a triangular wave generator circuit.

FIG. 3 is a diagram illustrating an example configuration where a current detector circuit is provided at a source side of a switching element.

FIG. 4 is a diagram illustrating an example configuration of an output voltage detector circuit.

FIG. 5 is a diagram illustrating an example configuration of a feedback circuit.

FIG. 6 is a detail configuration diagram illustrating major part of a switching control circuit.

FIG. 7 is a detail configuration diagram illustrating major part of a switching control circuit.

FIG. 8 is a block diagram of a switching power supply according to a second embodiment.

FIG. 9 is a block diagram of a switching power supply according to a third embodiment.

FIG. 10 is a block diagram of a switching power supply according to a fourth embodiment.

FIG. 11 is a block diagram of a modified example of the switching power supply according to the fourth embodiment.

FIG. 12 is a block diagram of a switching power supply according to a fifth embodiment.

FIG. 13 is a diagram illustrating an example configuration of a feedback circuit.

FIG. 14 is a block diagram of a modified example of the switching power supply according to the fifth embodiment.

FIG. 15 is a block diagram of a switching power supply according to a sixth embodiment.

FIG. 16 is a diagram illustrating an example configuration of a feedback circuit.

### DETAILED DESCRIPTION OF THE INVENTION

Hereinafter, best modes of the present invention will be described with reference to the accompanying drawings.

### First Embodiment

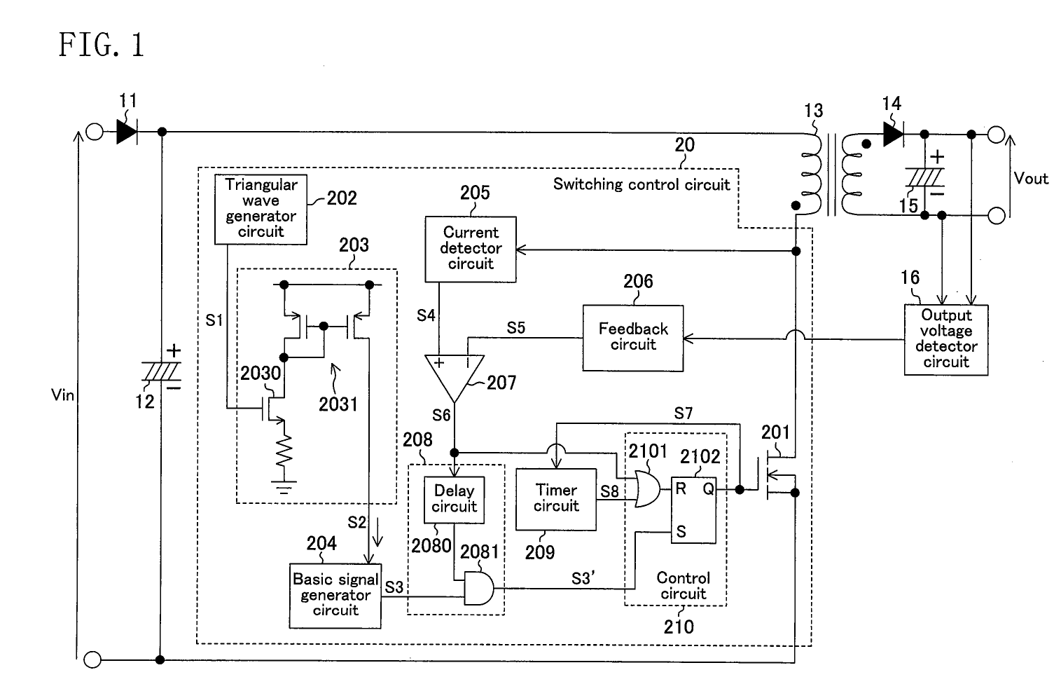

FIG. 1 is a block diagram of a switching power supply according to a first embodiment. An input rectifier diode 11 and an input smoothing capacitor 12 rectify and smooth an alternate current input Vin and supply a direct current to a primary side of a transformer 13. An output rectifier diode 14 and an output smoothing capacitor 15 rectify and smooth a secondary current of the transformer 13 and generate a direct current output Vout. A switching control circuit 20 controls supply of a primary current to the transformer 13. Specifically, the supply of the primary current to the transformer 13 is controlled by ON/OFF operation of a switching element 201 connected to a primary winding. Note that the switching control circuit 20 can be configured as a single semiconductor chip. The switching element 201 may be provided outside the switching control circuit 20.

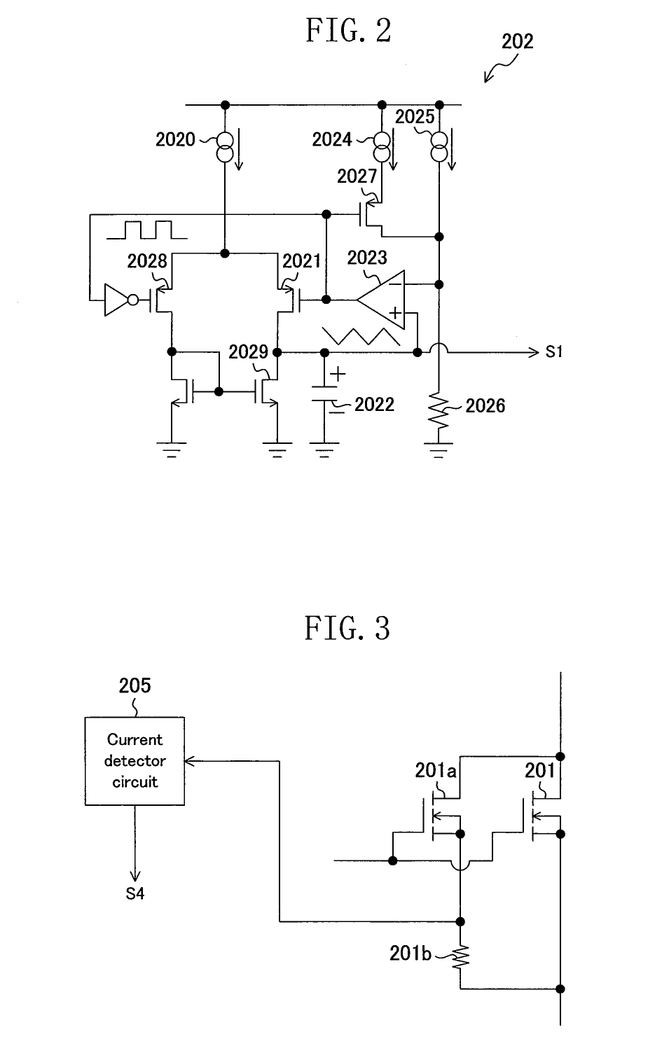

In the switching control circuit 20, a triangular wave generator circuit 202 generates a triangular wave signal S1. FIG. 2 is a diagram illustrating an example configuration of the triangular wave generator circuit 202. An electric charge is supplied from a constant current source 2020 to a capacitor 2022 via a switching element 2021. A comparator 2023 compares a first reference voltage generated by constant current sources 2024 and 2025 and a resistance element 2026 to a voltage of the capacitor 2022. When the voltage of the capacitor 2022 reaches the first reference voltage, switching elements 2021 and 2027 are controlled to be non-conductive and a switching element 2028 is controlled to be conductive by an output of the comparator 2023. Thus, a switching element 2029 becomes conductive and a voltage of the capacitor 2022 is reduced. Then, when the voltage of the capacitor 2022 reaches a second reference voltage generated by the low current source 2025 and the resistance element 2026, the switching elements 2021 and 2027 are controlled to be conductive and the switching element 2028 is controlled to be non-conductive by an output of the comparator 2023. By repeating the above-described operation, the voltage of the capacitor 2022 becomes the triangular wave signal S1 which varies between the first reference voltage and the second reference voltage.

Returning to FIG. 1, a fluctuation generator circuit 203 generates a fluctuating signal S2, based on the triangular wave signal S1. Specifically, the triangular wave signal S1 is input to a gate of a transistor 2030. The transistor 2030 is connected to an input side of a current mirror circuit 2031. Thus, a current which fluctuates according to the triangular wave signal S1 is output from the current mirror circuit 2031. This current becomes the fluctuating signal S2. A basic signal generator circuit 204 generates a PWM basic signal S3 whose frequency fluctuates according to the fluctuating signal S2.

Note that the frequency of the fluctuating signal S2 is preferably about 10% of the PWM basic frequency even at highest setting. For example, when the PWM basic frequency is 100 kHz and the frequency of the fluctuating signal S2 is 10 kHz, the PWM basic signal S3 varies between 100 kHz and 110 kHz.

A current detector circuit 205 detects a current flowing through the switching element 201 and outputs a detection signal S4. The current detector circuit 205 may be provided at a source side of the switching element 201. FIG. 3 is a diagram illustrating an example configuration where the current detector circuit 205 is provided at the source side of the switching element 201. In this case, a sense element 201 a and a sense resistor 201 b for flowing a sufficiently smaller current than that of the switching element 201 are provided in parallel to the switching element 201. The current detector circuit 205 indirectly detects, from a voltage of the sense resistor 201b, a current flowing through the switching element 201.

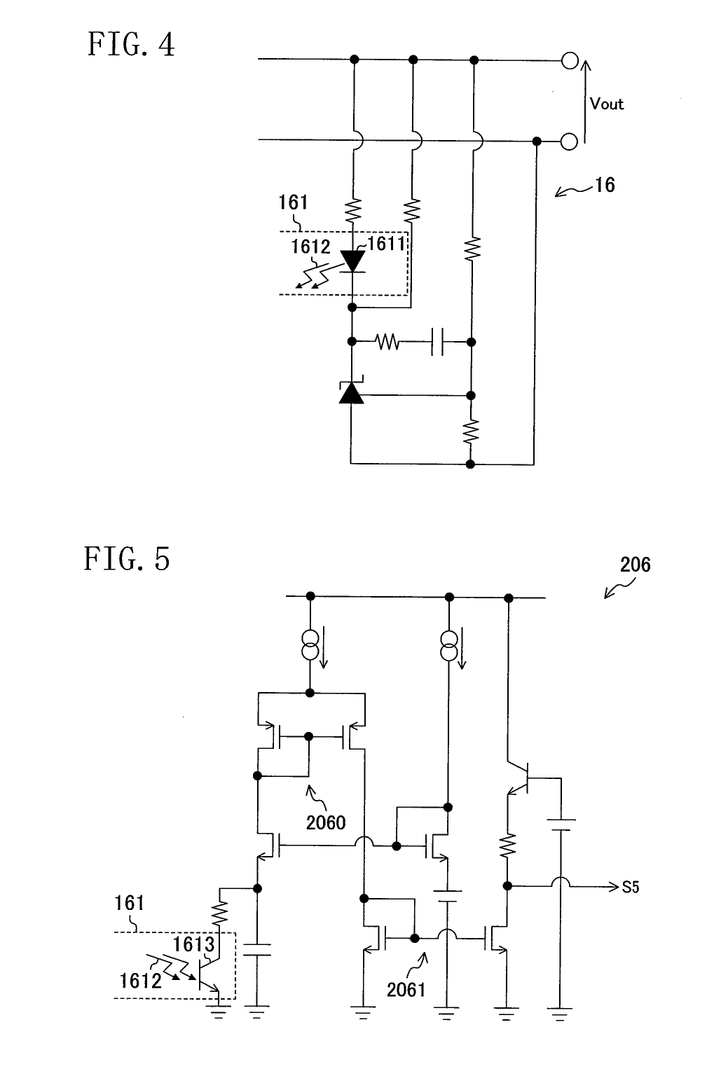

Returning to FIG. 1, a feedback circuit 206 generates a feedback signal S5 which is to be a target value of the detection signal S4, based on the direct current output Vout detected by an output voltage detector circuit 16. FIG. 4 and FIG. 5 illustrate an example configuration of the output voltage detector circuit 16 and an example configuration of the feedback circuit 206, respectively. A light emitting diode 1611 of a photocoupler 161 outputs light 1612 at a light intensity corresponding to the direct current output Vout. A photo transistor 1613 of the photocoupler 161 receives the light 1612. A current flowing through the photo transistor 1613 is converted to the feedback signal S5 via current mirror circuits 2060 and 2061. Note that when the transformer 13 includes an auxiliary winding, the output voltage detector circuit 16 may be configured to detect an output of the auxiliary winding, instead of the direct current output Vout.

Returning to FIG. 1, a comparator 207 compares the detection signal S4 to the feedback signal S5 and, when the detection signal S4 reaches the feedback signal S5, the comparator 207 outputs an OFF signal S6. When receiving the OFF signal S6, a mask circuit 208 masks the PWM basic signal S3 for a certain period. This is to ensure a time period in which the switching element 201 is non-conductive in order to completely block a current flowing through the switching element 201. Specifically, a delay circuit 2080 outputs the OFF signal S6 with a delay. Then, an AND gate 2081 outputs a logical product (S3′) of the PWM basic signal S3 and an output of the delay circuit 2080. When receiving a signal S7 for controlling the switching element 201, a timer circuit 209 measures an elapsed, predetermined longer time than one cycle of the PWM basic signal S3 since a start of ON control of the switching element 201 to output an OFF signal S8. A control circuit 210 ON controls the switching element 201 when receiving the PWM basic signal S3′, and OFF controls the switching element 201 when receiving either one of the OFF signals S6 and S8. Specifically, the control circuit 210 includes an SR latch circuit 2102 which is set by the PWM basic signal S3′, is reset by an output of an OR gate 2101 to which the OFF signals S6 and S8 are input, and outputs the signal S7. Thus, when the SR latch circuit 2102 is once set, the switching element 201 is continuously ON controlled until the SR latch circuit 2102 is reset, whether or not the PWM basic signal S3 is input.

Note that if an elapsed time since a start of ON control of the switching element 201 until the timer circuit 209 outputs the OFF signal S8 is set to be too long and thus the switching frequency is reduced to an audible field, noise is caused. Therefore, a time which the timer circuit 209 measures is preferably set so that the switching frequency does not become 20 kHz or less.

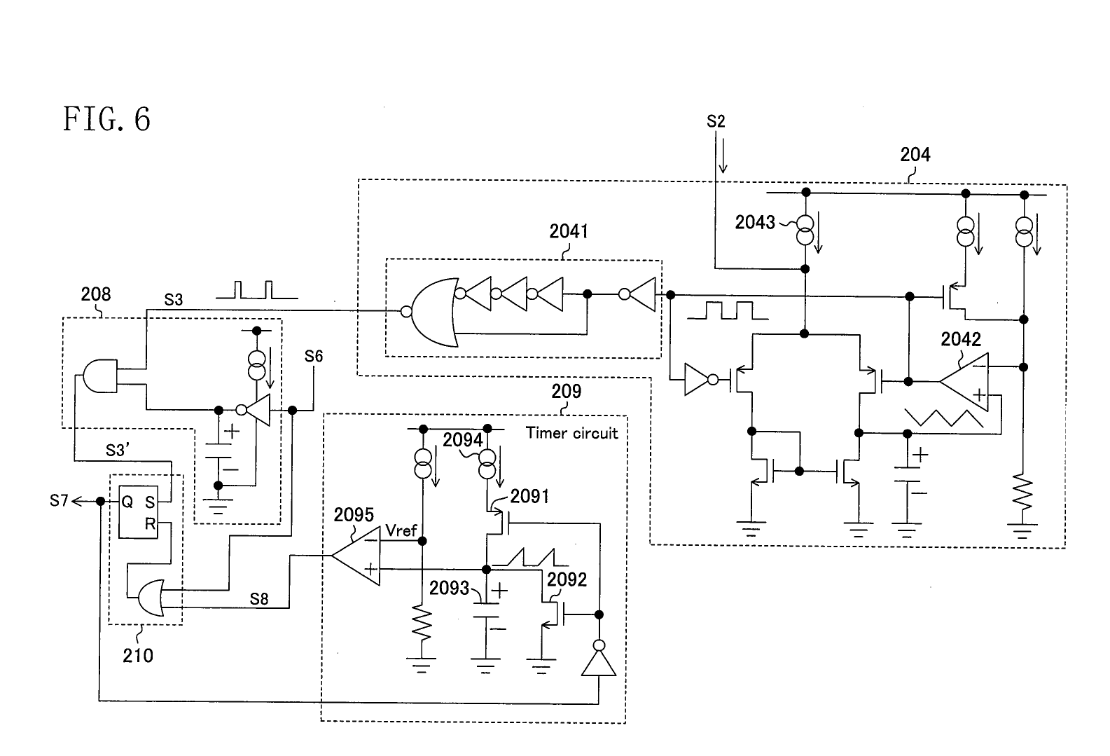

FIG. 6 is a detail configuration diagram illustrating major part of the switching control circuit 20. The basic signal generator circuit 204 can be configured by adding a one-shot pulse generator circuit 2041 to the configuration of the triangular wave generator circuit 202 of FIG. 2. The one-shot pulse generator circuit 2041 converts a rectangular wave signal output from a comparator 2042 into a one-shot pulse, and outputs it as the PWM basic signal S3. The fluctuating signal S2 is input to an output side of a constant current source 2043. In the timer circuit 209, a switch 2091 is in a conductive state while the switching element 201 is ON controlled, and is in a non-conductive state while the switching element 201 is OFF controlled. A switch 2092 operates reversely to the switch 2091. While the switching element 201 is ON controlled, an electric charge is supplied to a capacitor 2093 from a constant current source 2094 via the switch 2091. The basic signal generator circuit 204 generates the PWM basic signal S3, regardless of the control state of the switching element 201. On the other hand, while the switching element 201 is OFF controlled, the switch 2092 is ON and a voltage of the capacitor 2093 is reduced. A comparator 2095 compares the voltage of the capacitor 2093 to a reference voltage Vref and, when the voltage of the capacitor 2093 reaches the reference voltage Vref, the comparator 2095 outputs the OFF signal S8. Note that a time that it takes for the capacitor 2093 to be charged from a discharged state to the reference voltage Vref is set to be longer than one cycle of the PWM basic signal S3.

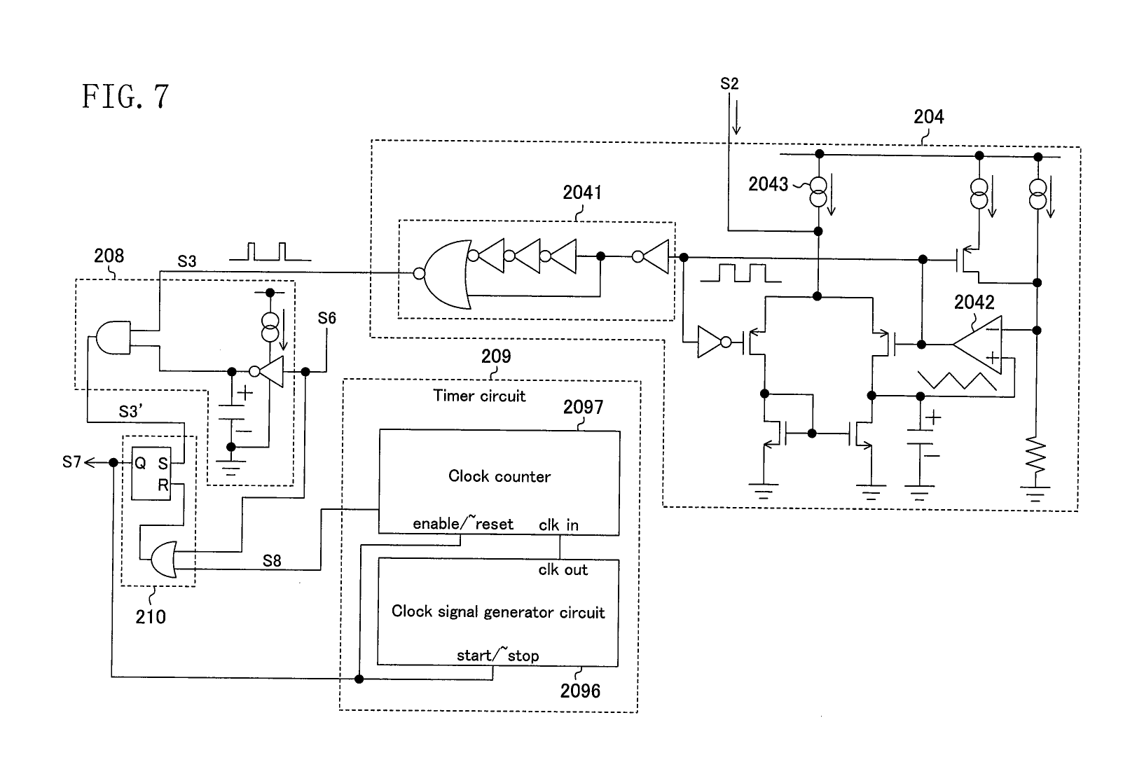

FIG. 7 is a detail configuration diagram illustrating major part of the switching control circuit 20. In the timer circuit 209, a clock signal generator circuit 2096 generates a clock signal having a higher frequency than that of the PWM basic signal S3. Since the clock signal need to be generated only when the switching element 201 is ON controlled, the clock signal generator circuit 2096 is preferably configured so as to operate/halt according to the signal S7. When receiving the signal S7, a clock counter 2097 counts edges of the clock signal generated by the clock signal generator circuit 2096 for a predetermined number of times since a start of ON control of the switching element 201, and then outputs the OFF signal S8. Also, when the switching element 201 is OFF controlled, the clock counter 2097 resets a count value. Note that the predetermined number is set so that an elapsed time since a start of ON control of the switching element 201 until the OFF signal S8 is output is set to be longer than one cycle of the PWM basic signal S3.

As described above, according to this embodiment, the power supply capacity when an input voltage is low can be improved by continuously ON controlling the switching element 201 for a longer time than one cycle of the PWM basic signal S3. Moreover, since the basic signal generator circuit 204 generates the PWM basic signal S3 regardless of the control state of the switching element 201, a switching cycle of the switching element 201 is a positive integer multiple of one cycle of the PWM basic signal S3. Therefore, peaks of the switching noise can be restricted to a PWM basic frequency and harmonic components thereof. Thus, switching noise suppression can be achieved in a simple manner. Furthermore, since the PWM basic frequency continuously varies according to the fluctuating signal S2, a spectrum of switching noise is spread and peaks of switching noise are suppressed.

Note that the alternate current input Vin may be full wave rectified using a diode bridge, instead of the input rectifier diode 11. Also, the frequency of the PWM basic signal S3 may be fixed. In that case, the triangular wave generator circuit 202 and the fluctuation generator circuit 203 are not necessary.

### Second Embodiment

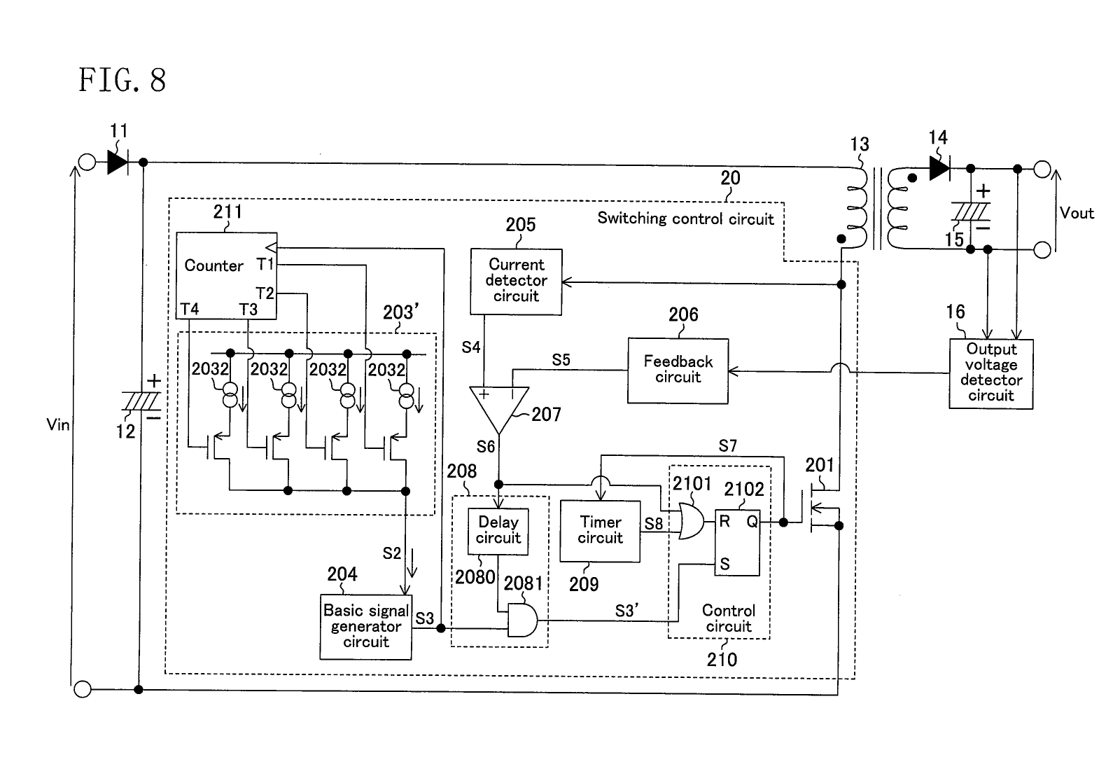

FIG. 8 is a block diagram of a switching power supply according to a second embodiment. The switching power supply according to this embodiment includes a counter 211 and a fluctuation generator circuit 203′, instead of the triangular wave generator circuit 202 and the fluctuation generator circuit 203 of the switching power supply of the first embodiment. Hereinafter, only different points from the first embodiment will be described.

The counter 211 performs a count operation in synchronization with the PWM basic signal S3, and outputs 4-bit signals T1 through T4. The counter 211 may be any one of an up-counter, a down-counter and an up/down-counter. The fluctuation generator circuit 203′ changes the number of parallel connections among four constant current sources 2032 according to an output value of the counter 211, and outputs, as the fluctuating signal S2, a sum current flowing therethrough. In this case, the fluctuating signal S2 can be adjusted in 16 levels by setting the four constant current sources in a power of two ratio. Thus, according to this embodiment, the PWM basic frequency varies in a discrete manner according to the fluctuating signal S2, so that the spectrum of switching noise is spread and peaks of the switching noise are suppressed.

### Third Embodiment

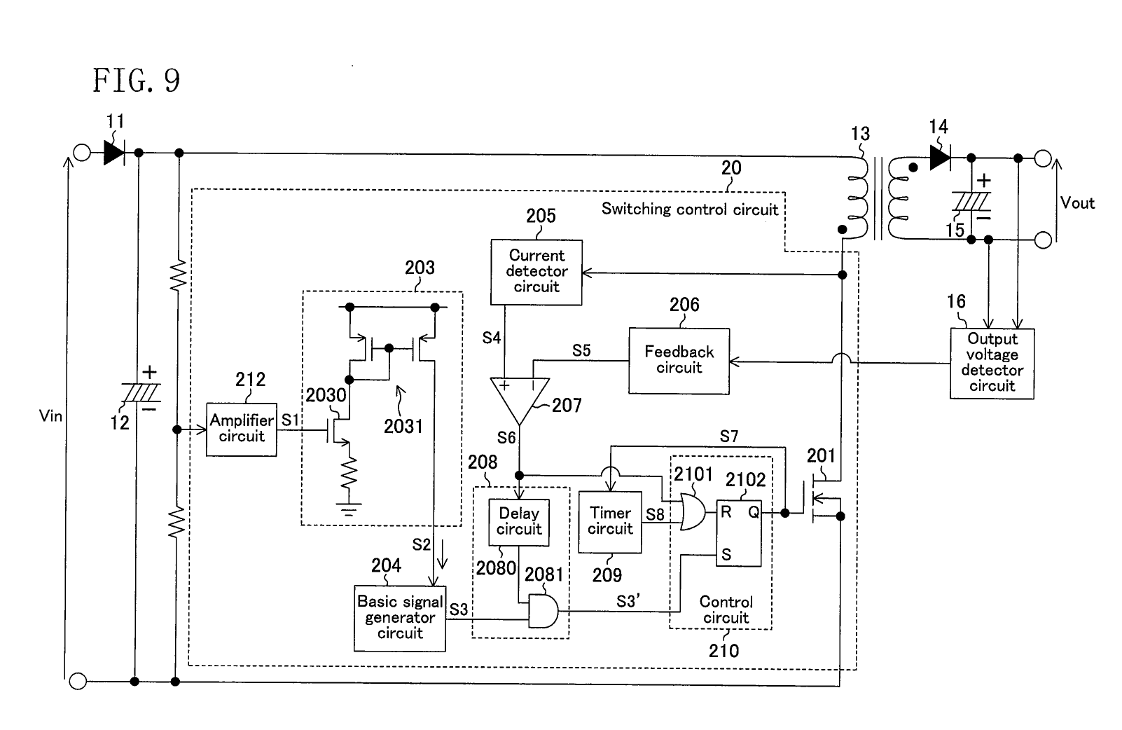

FIG. 9 is a block diagram of a switching power supply according to a third embodiment. The switching power supply according to this embodiment includes an amplifier circuit 212, instead of the triangular wave generator circuit 202 of the switching power supply of the first embodiment. Hereinafter, only different points from the first embodiment will be described.

The amplifier circuit 212 amplifies an intermediate voltage of the input smoothing capacitor 12, and outputs the signal S1. That is, the amplifier circuit 212 amplifies an input ripple of the switching power supply. Specifically, the amplifier circuit 212 can be formed of an operational amplifier, a mirror circuit or the like. The fluctuation generator circuit 203 generates the fluctuating signal S2, based on the signal S1. Thus, according to this embodiment, the fluctuating signal S2 is generated using the input ripple of the switching power supply, and thus a triangular wave based on which the fluctuating signal S2 is generated does not have to be artificially generated. Therefore, a circuit size of the switching power supply of this embodiment can be made smaller than that of the first embodiment. Moreover, a fluctuation amount of the fluctuating signal S2 can be adjusted by changing a capacity value of the input smoothing capacitor 12.

### Fourth Embodiment

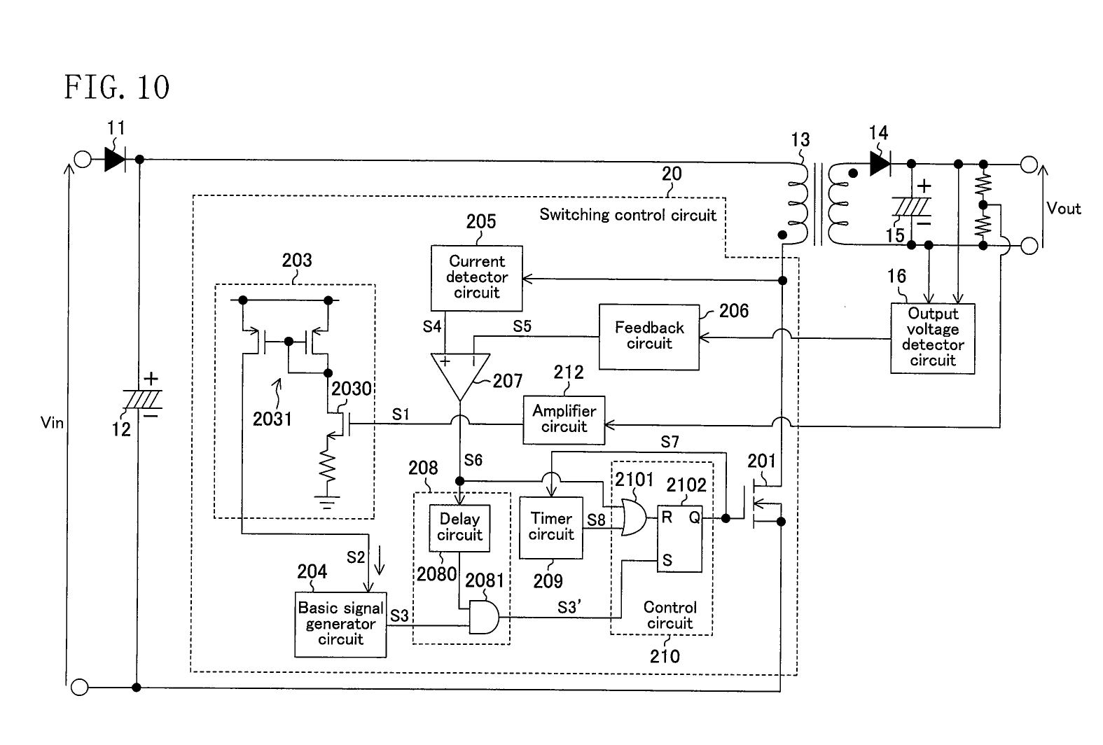

FIG. 10 is a block diagram of a switching power supply according to a fourth embodiment. The switching power supply of this embodiment includes the amplifier circuit 212, instead of the triangular wave generator circuit 202 of the switching power supply of the first embodiment. Hereinafter, only different points from the first embodiment will be described.

The amplifier circuit 212 amplifies the intermediate voltage of the output smoothing capacitor 15, and outputs the signal S1. That is, the amplifier circuit 212 amplifies an output ripple of the switching power supply. Specifically, the amplifier circuit 212 can be formed of an operational amplifier, a mirror circuit or the like. The fluctuation generator circuit 203 generates the fluctuating signal S2, based on the signal S1. Thus, according to this embodiment, the fluctuating signal S2 is generated using the output ripple of the switching power supply, and a triangular wave based on which the fluctuating signal S2 is generated does not have to be artificially generated. Therefore, a circuit size of the switching power supply of this embodiment can be made smaller than that of the first embodiment. Moreover, a fluctuation amount of the fluctuating signal S2 can be adjusted by changing a capacity value of the output smoothing capacitor 15.

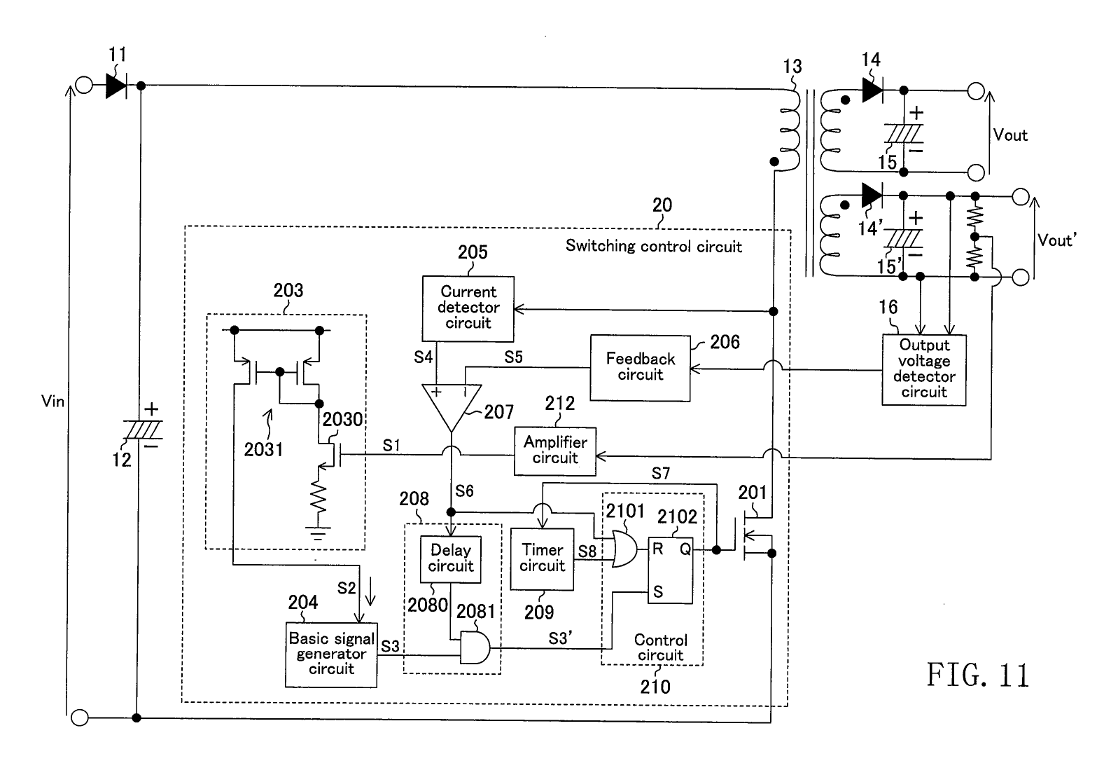

When the transformer 13 includes an auxiliary winding, the output voltage detector circuit 16 may be configured to detect an output of the auxiliary winding, instead of the direct current output Vout. FIG. 11 is a block diagram of a modified example of the switching power supply of this embodiment. An output rectifier diode 14′ and an output smoothing capacitor 15′ rectify and smooth an auxiliary winding output of the transformer 13, and generate a direct current output Vout′ having the same phase as the direct current output Vout. The output voltage detector circuit 16 detects the direct current output Vout′. Moreover, the amplifier circuit 212 amplifies the intermediate voltage of the output smoothing capacitor 15′ and outputs the signal S1. A capacity value of the output smoothing capacitor 15 can not be changed more then it is unnecessary because it directly affects the direct current output Vout. In contrast, the auxiliary winding is provided solely for the purpose of feedback control of the switching power supply, and thus a capacity value of the output smoothing capacitor 15′ can be freely changed without affecting the direct current output Vout. Therefore, the degree of freedom in power supply design is improved by using the auxiliary winding output.

### Fifth Embodiment

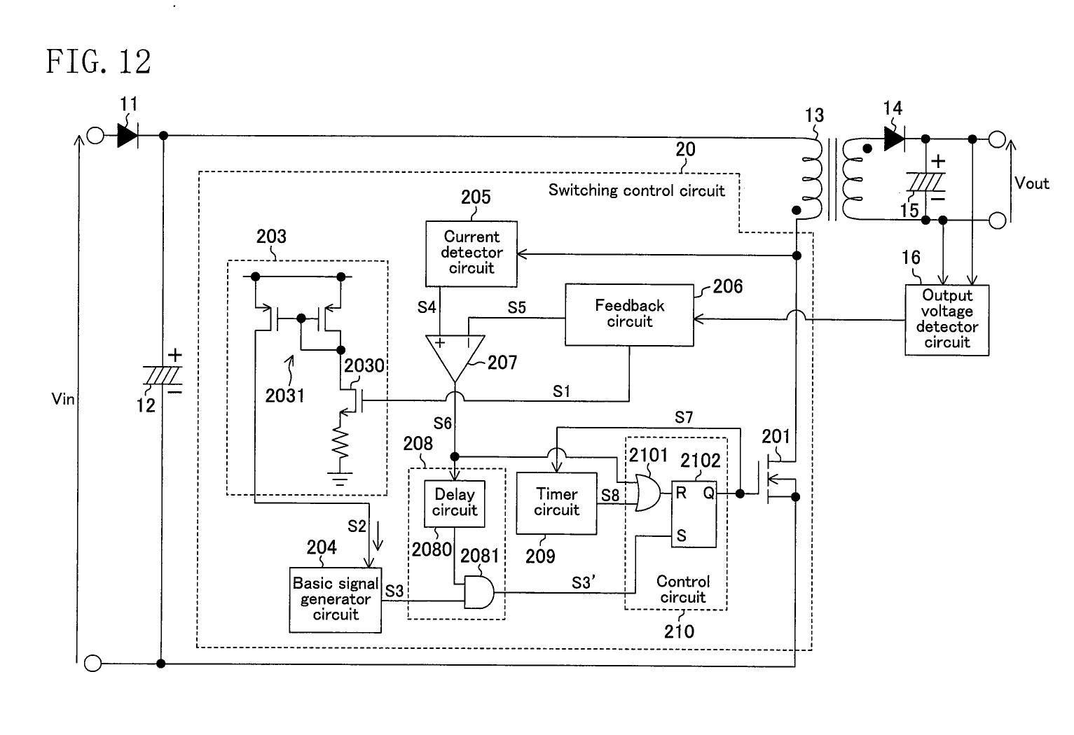

FIG. 12 is a block diagram of a switching power supply according to a fifth embodiment. The switching power supply of this embodiment is configured by omitting the triangular wave generator circuit 202 of the switching power supply of the first embodiment, so that the signal S1 is supplied from the feedback circuit 206 to the fluctuation generator circuit 203. Hereinafter, only different points from the first embodiment will be described.

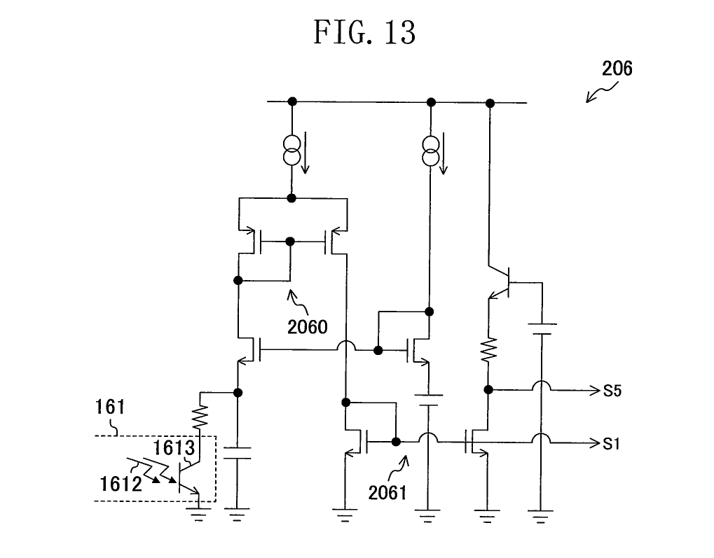

The feedback circuit 206 amplifies an output ripple in the course of generating the feedback signal S5. Therefore, an internal signal of the feedback circuit 206 can be supplied as the signal S1 to the fluctuation generator circuit 203. FIG. 13 is a diagram illustrating an example configuration of the feedback circuit 206. The feedback circuit 206 has exactly the same configuration as that shown in FIG. 5. In this case, a gate voltage of a current mirror circuit 2061 can be used as the signal S1. Thus, according to this embodiment, it is not necessary to additionally provide a circuit for generating the signal S1 based on which the fluctuating signal S2 is generated, and, therefore, a circuit size of the switching power supply can be made smaller than that of any one of the described other embodiments.

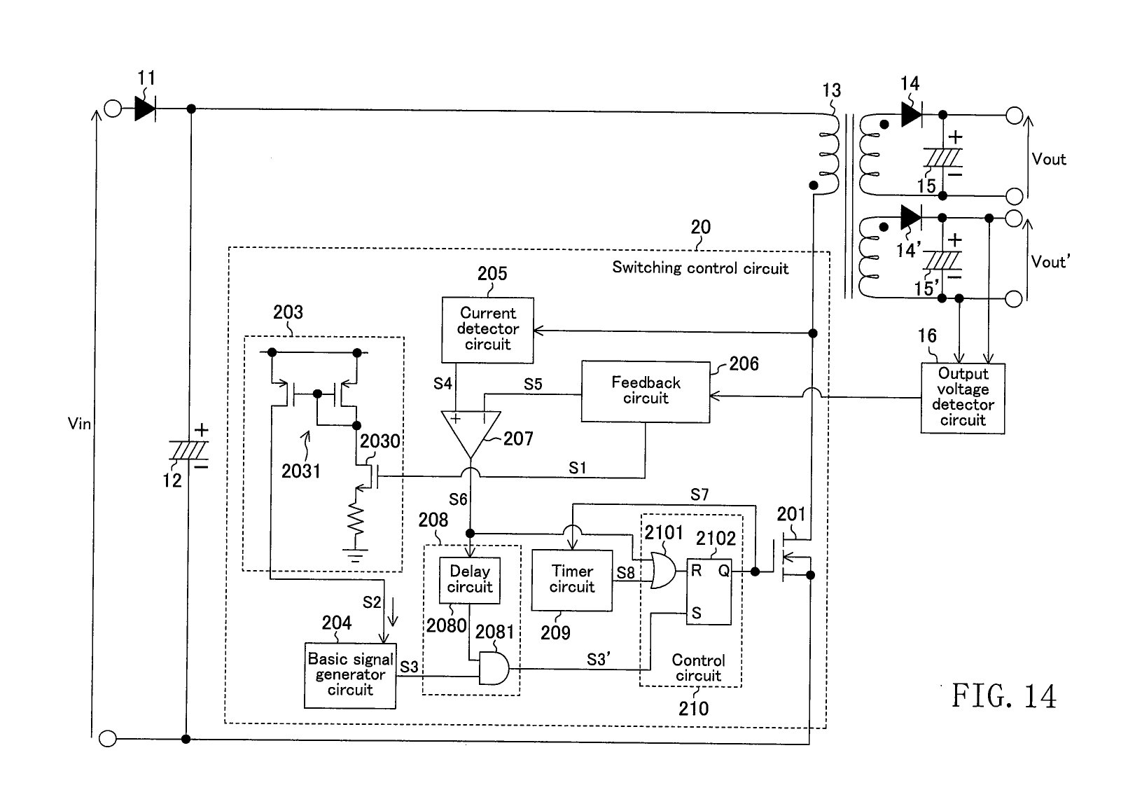

When the transformer 13 includes an auxiliary winding, as described above, the output voltage detector circuit 16 may be configured to detect an output of the auxiliary winding, instead of the direct current output Vout. FIG. 14 is a block diagram of a modified example of the switching power supply according to this embodiment. The degree of freedom in power supply design is improved by using the auxiliary winding output.

### Sixth Embodiment

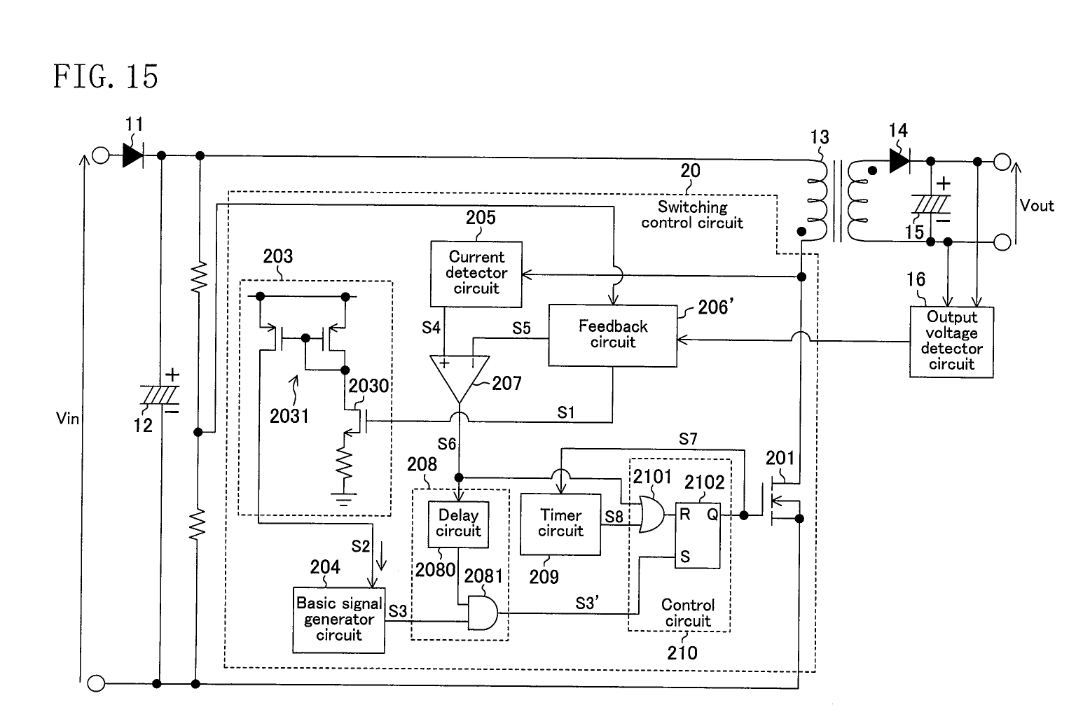

FIG. 15 is a block diagram of a switching power supply according to a sixth embodiment. The switching power supply of this embodiment includes, instead of the feedback circuit 206 of the switching power supply of the fifth embodiment, a feedback circuit 206′ for generating the signal S1 and the feedback signal S5, based on the intermediate voltage of the input smoothing capacitor 12 and the direct current output Vout. Hereinafter, only different points from the fifth embodiment will be described.

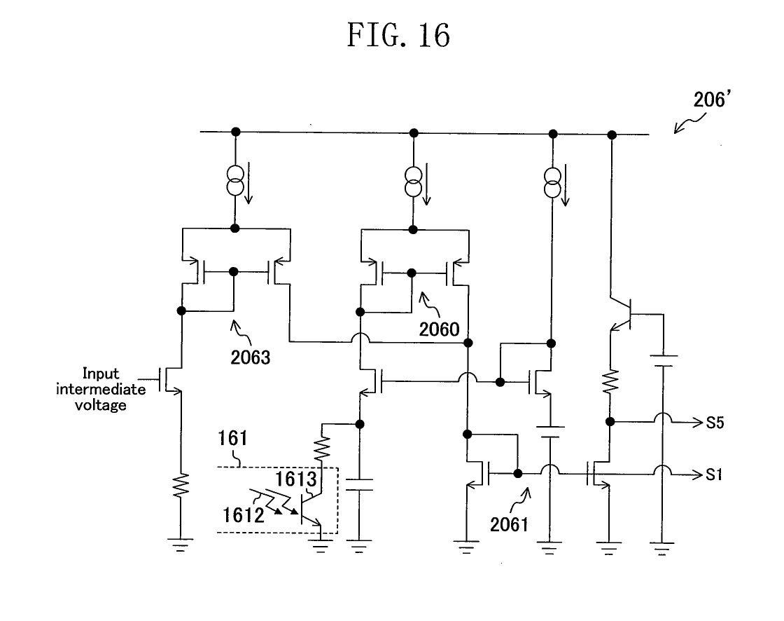

FIG. 16 is a diagram illustrating an example configuration of the feedback circuit 206′. The feedback circuit 206′ has a configuration obtained by adding a current mirror circuit 2063 and other components to the feedback circuit 206 of FIG. 13. The current mirror circuit 2063 outputs a current at an amount corresponding to the intermediate voltage of the input smoothing capacitor 12. An output of the current mirror circuit 2063 is synthesized with an output of the current mirror circuit 2060, and a resultant current is converted into the signal S1 and the feedback signal S5 via the current mirror circuits 2060 and 2061.

As described above, according to this embodiment, the fluctuating signal S2 is generated using the input ripple and output ripple of the switching power supply. Specifically, two parameters, i.e., the capacity value of the input smoothing capacitor 12 and the capacity value of the output smoothing capacitor 15 can be used for adjusting the fluctuation amount of the PWM basic frequency, and, therefore, the degree of freedom in power supply design is improved.

Note that, when the transformer 13 includes an auxiliary winding, the output voltage detector circuit 16 may be configured to detect an output of the auxiliary winding, instead of the direct current output Vout.

What is claimed is:

1. A switching control circuit for performing PWM control of a switching element which controls supply of a primary current to a transformer in a switching power supply for converting input power to direct current power, the switching control circuit comprising:
a basic signal generator circuit for generating a PWM basic signal regardless of a control state of the switching element;
a timer circuit for measuring an elapsed, predetermined longer time than one cycle of the PWM basic signal since a start of ON control of the switching element; and
a control circuit for ON controlling the switching element when receiving the PWM basic signal, and OFF controlling the switching element when receiving either one of a first OFF signal based on output feedback of the switching power supply and a second OFF signal based on completion of time measuring by the timer circuit.

2. The switching control circuit of claim 1, further comprising a mask circuit for masking, when receiving the first OFF signal, the PWM basic signal to be input to the control circuit for a certain period.

3. The switching control circuit of claim 1,
wherein the timer circuit includes:
a constant current source;
a capacitor having one end grounded;
a first switch, connected between an output end of the constant current source and the other end of the capacitor, for switching between a conductive state and a non-conductive state so that the first switch is in the conductive state while the switching element is ON controlled, and is in the non-conductive state while the switching element is OFF controlled;
a second switch, connected in parallel to the capacitor, for switching between a conductive state and a non-conductive state so that the second switch is in the non-conductive state while the switching element is ON controlled, and is in the conductive state while the switching element is OFF controlled; and
a comparator for comparing a charge voltage of the capacitor to a reference voltage.

4. The switching control circuit of claim 1,
wherein the timer circuit includes:
a clock signal generator circuit for generating a clock signal having a higher frequency than that of the PWM basic signal; and
a clock counter for counting edges of the clock signal for a predetermined number of times since a start of ON control of the switching element.

5. The switching control circuit of claim 1, wherein the basic signal generator circuit causes a frequency of the PWM basic signal to fluctuate according to a fluctuating signal input to the basic signal generator circuit.

6. The switching control circuit of claim 5, further comprising:
a triangular wave generator circuit for generating a triangular wave signal; and
a fluctuation generator circuit for generating the fluctuating signal, based on the triangular wave signal.

7. The switching control circuit of claim 5, further comprising:
a counter for performing a count operation; and
a fluctuation generator circuit, including a plurality of constant current sources, for changing a number of parallel connections among the plurality of constant current sources according to an output value of the counter and outputting, as the fluctuating signal, a sum current flowing therethrough.

8. The switching control circuit of claim 5, further comprising:
an amplifier circuit for amplifying an input ripple of the switching power supply; and
a fluctuation generator circuit for generating the fluctuating signal, based on an output of the amplifier circuit.

9. The switching control circuit of claim 5, further comprising:
an amplifier circuit for amplifying an output ripple of the switching power supply; and
a fluctuation generator circuit for generating the fluctuating signal, based on an output of the amplifier circuit.

10. The switching control circuit of claim 5, further comprising:
an amplifier circuit for amplifying an output ripple of an auxiliary winding of the transformer; and
a fluctuation generator circuit for generating the fluctuating signal, based on an output of the amplifier circuit.

11. The switching control circuit of claim 5, further comprising:
a feedback circuit for receiving a detection of an output of the switching power supply to generate a feedback signal based on which the first OFF signal is generated; and
a fluctuation generator circuit for generating the fluctuating signal, based on an output ripple of the switching power supply amplified by the feedback circuit.

12. The switching control circuit of claim 5, further comprising:
a feedback circuit for receiving a detection of an output of an auxiliary winding of the transformer to generate a feedback signal based on which the first OFF signal is generated; and
a fluctuation generator circuit for generating the fluctuating signal, based on an output ripple of the auxiliary winding amplified by the feedback circuit.

13. The switching control circuit of claim 5, further comprising:
a feedback circuit for receiving a detection of an input of the switching power supply and a detection of an output of the switching power supply to generate a feedback signal based on which the first OFF signal is generated; and
a fluctuation generator circuit for generating the fluctuating signal, based on an input ripple and an output ripple of the switching power supply which are synthesized and amplified by the feedback circuit.

14. The switching control circuit of claim 5, further comprising:
a feedback circuit for receiving a detection of an input of the switching power supply and a detection of an output of the auxiliary winding of the transformer to generate a feedback signal based on which the first OFF signal is generated; and
a fluctuation generator circuit for generating the fluctuating signal, based on an input ripple of the switching power supply and an output ripple of the auxiliary winding of the transformer which are synthesized and amplified by the feedback circuit.

15. A switching power supply for converting input power to direct current power comprising:
a transformer;
a switching element, connected to a primary winding of the transformer, for controlling supply of a primary current to the transformer;
a rectifier element, connected to a secondary winding of the transformer, for rectifying a secondary current of the transformer;
a smoothing element for smoothing a current rectified by the rectifier element to generate a direct current voltage;
a basic signal generator circuit for generating a PWM basic signal regardless of a control state of the switching element;
a timer circuit for measuring an elapsed, predetermined longer time than one cycle of the PWM basic signal since a start of ON control of the switching element; and
a control circuit for ON controlling the switching element when receiving the PWM basic signal, and OFF controlling the switching element when receiving either one of a first OFF signal based on output feedback of the switching power supply and a second OFF signal based on completion of time measuring by the timer circuit.
